(19) United States
(12) Patent Application Publication
(10) Pub. No.: US 2010/0324963 A1
(43) Pub. Date: Dec. 23, 2010

(54) TAG PRESENCE ALERTS FOR GROUPS AND MEETING

(75) Inventors: Amit Gupta, Redmond, WA (US); Rajesh Ramanathan, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/486,762

(22) Filed: Jun. 18, 2009

(51) Int. Cl. G06Q 10/00; G06F 15/16

(52) U.S. Cl. 705/9; 709/204; 709/206

(57) ABSTRACT

Architecture for enabling a group of contacts of a communications framework to be tagged for concurrent availability and participation in a communications session. The status of the contacts is monitored to detect availability of the contacts, and to determine when the contacts are available concurrently to participate in the communications session. A notification is sent to a tagging user of the concurrent availability of the contacts, at which time a meeting can be initiated. A context can be input that serves as a reminder as to the purpose of the communications session. The context can be presented in the notification with the availability status of the contacts. The status can be monitored by subscribing to presence information of the contacts. A contact list can be maintained to identify the contacts to be tagged and includes metadata related to each contact.

### BACKGROUND

In the workplace and other business settings, it is beneficial to schedule meetings among coworkers, collaborators, managers, sales representatives, and other members of the organization. Meetings are used for discussing ongoing projects, business development, planning, strategies, review of past performance, and analysis of trends, for example.

It can be difficult to plan meetings since attendees can be out of the office on business or personal matters, or in the office focused on important projects, project deadlines, or dealing with other unexpected situations that require attention. Such daily dynamics can affect the ability to maintain scheduled meetings and further exacerbate meeting scheduling where many participants are intended to be in attendance.

Systems exist where a user (a publisher) can expose presence information in which a status of the user indicates an availability to communicate with other users. The other network users (or watchers) can subscribe to the presence information of the user in order to monitor the presence state.

Presence systems enable watchers to tag a publisher user to receive a presence notification when the presence state of the publisher user changes, such as when the user becomes available for communications. However, such presence systems can only monitor individual users and cannot be used for monitoring a group of users.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for enabling a watcher user to receive a notification for availability of a group of users on a network, in order to plan and coordinate a meeting, for example. A “meeting” as described herein can include any communications session such as a communication session scheduled for a future date/time or an ad hoc communication session initiated instantly by a group of users, for example. A group of users can be tagged and the presence state of the group is monitored, to detect changes in status as a group. Upon determining that the group of users is available, the watcher user is notified of the availability. Additionally, a meeting can be tagged that already has an associated list of meeting attendees.

The watcher user can also tag a group of users to communicate or discuss (e.g., an ad hoc conversation) rather than coordinate a meeting time. The watcher can tag a group of people and the system can notify the watcher user when all members of the group are available or online. The watcher user can tag a meeting that has multiple participants having the same intention of receiving a notification when all participants are available or online. In an additional scenario, the watcher user can receive notification when the watcher user is also available, rather than receive a notification when the watcher user is busy. The tag can be a smart tag to notify when all parties are available free.

By tagging a meeting to a group for presence, the meeting can start automatically as soon as the group of users is available. In this manner, a meeting does not have to be delayed such that available participants are held waiting until the entire group of users or a quorum thereof joins the meeting. By tagging the meeting, the meeting can start when the entire group of users is available, and the entire group is notified at the same time. For example, the telephones of each of the group members can ring automatically at the same time to provide notification. Each of the users can pick up their phones to join the conference.

In addition to tagging a group of users or a meeting, the user can also leave a note as a reminder of the context (reason or purpose) of why the user made the tag. The context information can be included in the availability notification. The context note can be left manually by the user. Alternatively, the context can be auto-populated by the system.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented system for performing availability notification of a group of meeting participants.

FIG. 2 illustrates an alternative embodiment of a notification system that includes additional entities for indicating context.

FIG. 3 illustrates an alternative embodiment of a notification system that includes additional entities for indicating presence and status change.

FIG. 4 illustrates an alternative embodiment of a notification system.

FIG. 5 illustrates an alternative embodiment of a notification system that includes additional entities for indicating presence, status, and contact.

FIG. 6 illustrates a method of tagging contacts and notifying when the contacts are available for a meeting.

FIG. 7 illustrates additional aspects of the method of tagging contacts and notifying when the contacts are available for a meeting.

FIG. 8 illustrates a flow chart of an implementation in accordance with the disclosed embodiments.

FIG. 9 illustrates a block diagram of a computing system operable to provide tagging and notification in accordance with the disclosed architecture.

FIG. 10 illustrates an exemplary computing environment operable to provide tagging and notification.

### DETAILED DESCRIPTION

The disclosed architecture enables users of a communications framework to be tagged as a group for participation in a communications session. A context (reason or purpose) is indicated for tagging the contacts, to serve as a reminder of the purpose of the communications session. The status of the contacts is monitored to detect an availability status of the contacts, and to determine when the contacts are concurrently available to participate in the communications session. A notification is sent to a watcher user or meeting organizer of the availability status of the contacts, at which time the communication session can be initiated. The context can be presented in the notification with the availability status of the contacts. The status can be monitored by subscribing to presence information of the contacts. A contact list can be maintained to identify the contacts to be tagged and can include metadata related to each contact.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

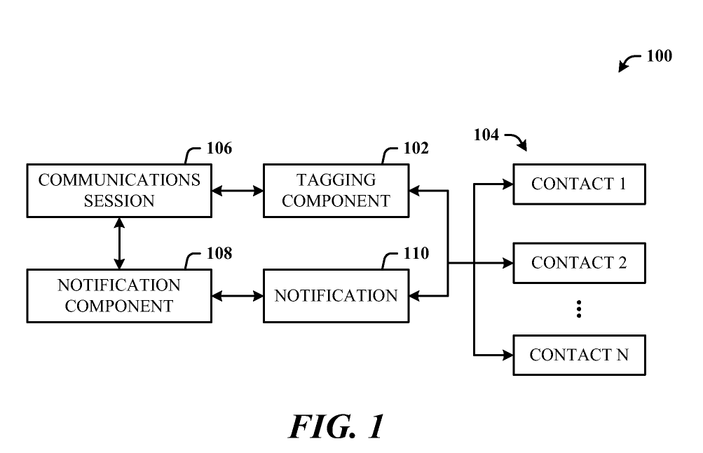

FIG. 1 illustrates a computer-implemented notification system 100 for performing availability notification of a group of meeting invitees or attendees in accordance with the disclosed architecture. A tagging component 102 is provided for tagging contacts 104 of a communications framework for participation in a communications session 106. The contacts 104 can be coworkers or collaborators in the same enterprise, for example, in communication over a common network or disparate networks. The contacts 104 can also include a watcher user, group session organizer, and/or other person that initially tagged the contacts 104. The contacts 104 to be tagged can also be members of an email distribution list, for example. The contacts 104 to be tagged can also be associated with meetings, as described in detail hereinbelow.

As also illustrated in FIG. 1, the tagging component 102 can be implemented by a group communication organizer, for example, to determine a time/date when the contacts 104 are available or to initiate an ad hoc instant communication session when all the contacts 104 are currently available. A notification component 108 is provided for sending a notification 110 when the tagged contacts 104 are concurrently available to participate in the communications session 106. The notification 110 can be sent directly to the meeting organizer, and/or can be sent to some or all the contacts 104. The tagging component 102 can tag contacts 104 from an email thread. The notification component 108 can use the email thread as the notification 110 to notify when the contacts 104 are available. As indicated hereinabove, the contacts 104 can be members of an email distribution list. It is within contemplation of the disclosed architecture that the notification 110 can be sent as well to a logging or tracking system to maintain such information for other purposes (e.g., legal).

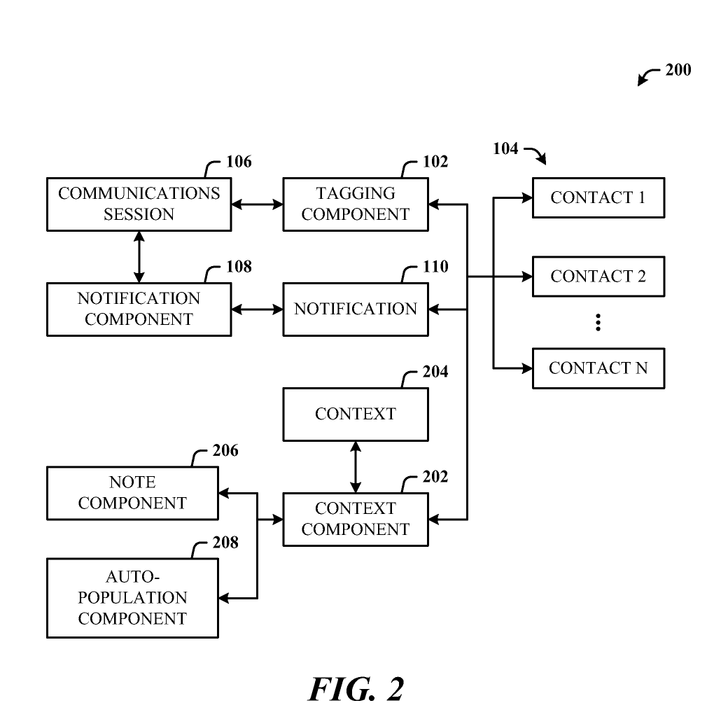

FIG. 2 illustrates an alternative embodiment of a notification system 200 that includes additional entities for indicating context. A context component 202 is provided for indicating a context 204 for the contacts 104. As used herein, “context” refers to the reason for which one or more of the contacts 104 are tagged such as a project meeting, upcoming travel arrangements, etc. This information is used to remind the meeting organizer (or “tagger”) as to the purpose for which the contacts 104 were tagged. This is especially useful if multiple meetings are planned in which some or all of the same contacts 104 are tagged, and/or the meetings are scheduled in advance over a long period of time. In this way, the organizer and/or contacts 104 can recall the purpose of the particular meeting.

As also illustrated in FIG. 2, a note component 206 (e.g., of the context component 202) can be provided for entering a note to indicate the context 204 of the tagged contacts 104. An auto-population component 208 can be provided for automatically populating the context 204. The auto-population component 208 can obtain information from other sources, such as a description of the meeting entered into another communications or scheduling application, for example. The auto-population component 208 can be used to auto-populate a note upon receiving the notification 110 in which the context 204 is presented.

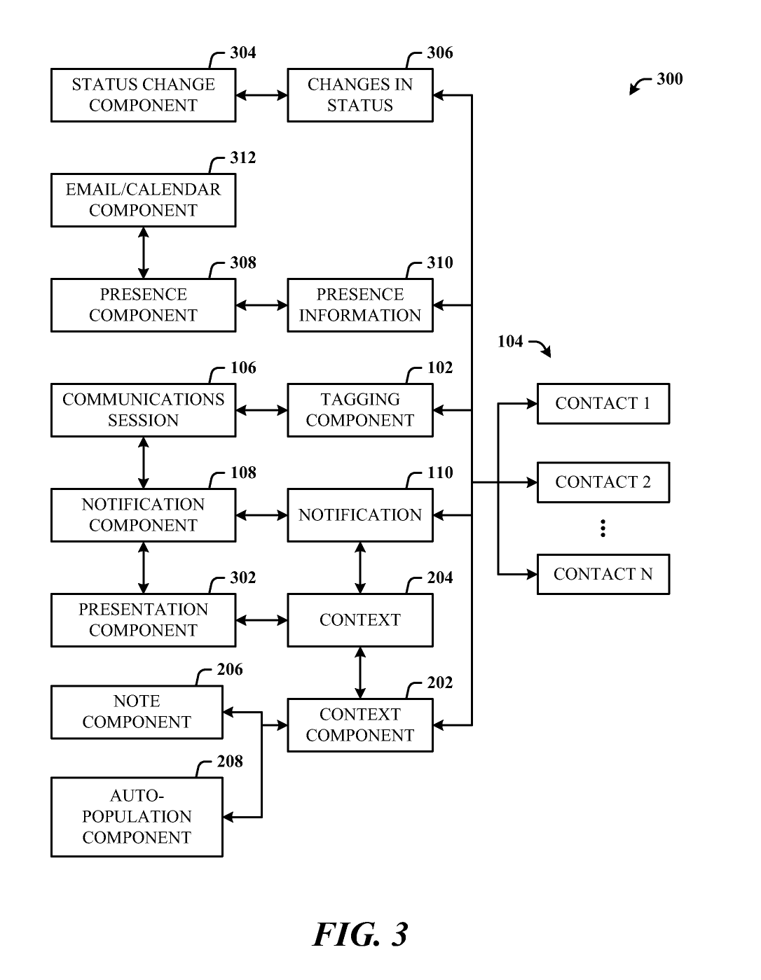

FIG. 3 illustrates an alternative embodiment of a notification system 300 that includes additional entities for indicating presence and status change. A presentation component 302 presents the context 204 in the notification 110. In this way, recipients of the notification 110 can receive the context 204 in the same message. A status change component 304 indicates change in status 306 of each of the contacts 104. The change in status 306 is of particular interest when the change indicates an availability of the tagged contact. The status change component 304 can cooperate with the notification component 108 so that the meeting organizer receives the notification 110 when the availability state of the tagged contacts indicates all tagged contacts are available.

Note that it is also within contemplation of the disclosed architecture that the tagging user is given a cumulative notification of the contacts becoming available. In other words, the notification process can be manipulated based on the composition of the contact group; as the contacts change state, the tagging user receives notification of two contacts being available, then three contacts, then four contacts, and so on, until all contacts are available. Alternatively, the composition can include tagging user can set a minimum number of the contacts (e.g., five) or a percentage (e.g., seventy percent) to begin cumulative notification. Still further, the notification can be sent based on a change in composition where more important contacts become available, such as in a project manager versus a staff stenographer, for example. Thus, the tagging user can decide that when most or all of the contacts deemed essential for the meeting or conference are available, the notification is sent, even though not all tagged contacts are available. The composition can also include an optional set of contacts, the required set of contacts.

As also illustrated in FIG. 3, a presence component 308 monitors presence information 310 of each of the contacts 104, to discover when (e.g., time, date, duration, etc.) the contacts 104 (or subset thereof) are concurrently available to participate in the session. It is to be appreciated that, as described herein, the contacts 104 can include a watcher user, group session organizer, and/or other person that initially tagged the contacts 104, for monitoring of presence information 310 by the presence component 308. The presence component 308 can work in conjunction with the status change component 304 to detect availability from status changes indicated specifically by the presence information 310.

As also illustrated in FIG. 3, the presence component 308 can also work in conjunction with an email/calendar component 312 associated with each of the contacts 104. The email/calendar component 312 can be monitored for email activity and/or scheduled calendar events that can be included in the presence information 310 for discovering availability of the contacts 104.

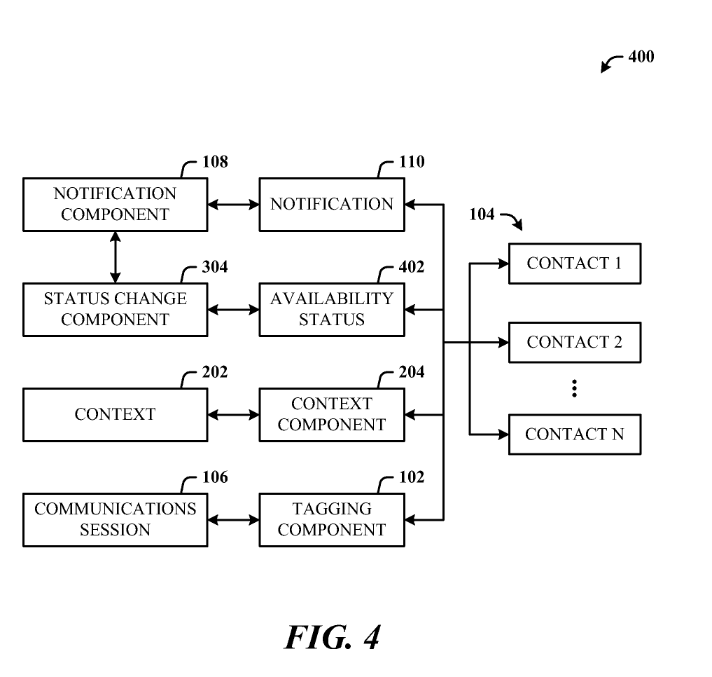

FIG. 4 illustrates an alternative embodiment of a notification system 400. A tagging component 102 is provided for tagging the contacts 104 of a communications framework for concurrent participation in a communications session 106. The context component 204 indicates the context 202 for tagging the contacts 104. The status change component 304 detects an availability status 402 of the contacts 104 to participate (e.g., concurrently) in the communications session 106.

As also illustrated in FIG. 4, the notification component 108 sends the notification 110 of the availability status 402 of the contacts 104. It is to be appreciated that the notification 110 can be sent to the meeting organizer, or additionally, the contacts 104, so that all potential meeting participants can be notified when everyone is available concurrently. The contacts 104 can also receive a notification upon initially being tagged, so that they can be forewarned and prepared for the meeting upon receiving the notification 110.

In the event that not all the contacts 104 can be available within a suitable opportunity window, it is also to be appreciated that the notification 110 can be sent when certain selected contacts 104 become available. The meeting can convene when a threshold number of contacts 104 are available, for example, upon obtaining a quorum (a simple majority). Alternatively, the meeting can convene when key personnel become available, such as a project manager or expert, for example. Certain contacts 104 can be tagged on the basis of a prioritization. For example, certain tagged contacts 104 can be on a “required list” and selected on the basis of expertise, position in management, or whether a contact is otherwise essential to the meeting agenda. Non-essential contacts 104 can either forego the meeting if unavailable, or change schedules to become available if required participants become available. In this manner, a notification 110 can be sent out and a meeting can convene though not all contacts 104 are available.

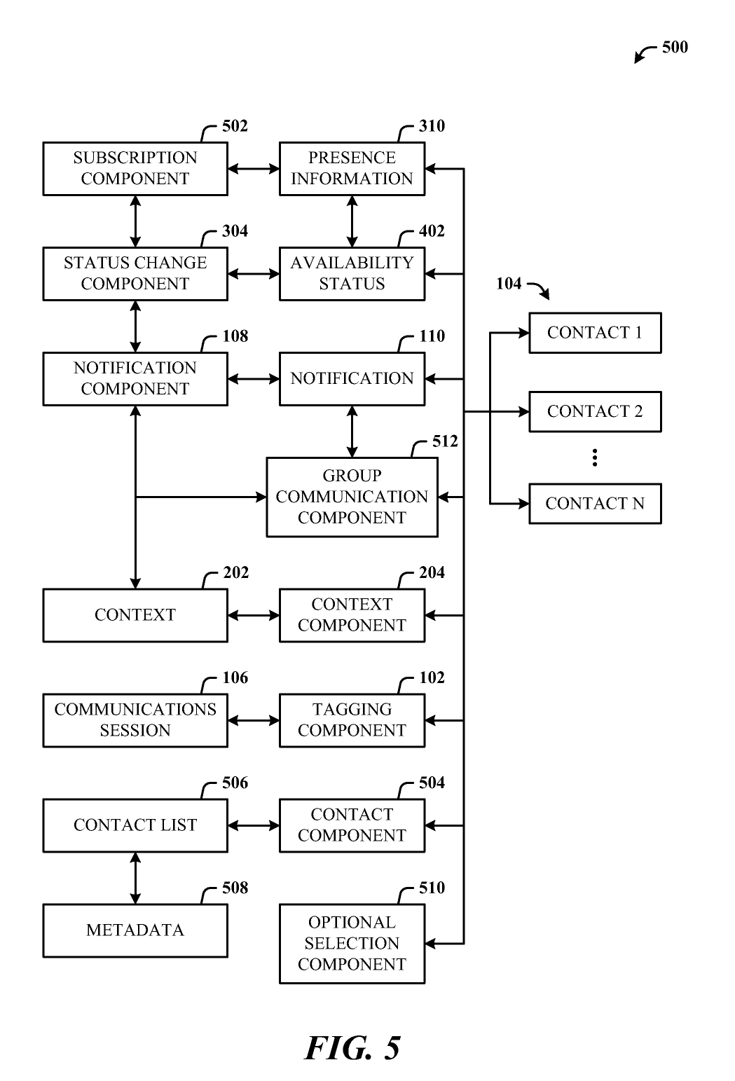

FIG. 5 illustrates an alternative embodiment of a notification system 500 that includes additional entities for indicating presence, status, and contact. A subscription component 502 can be used to subscribe to the presence information 310 of the contacts 104. The subscription component 502 can cooperate with the status change component 304 to use the presence information 310 to determine the availability status 402 of the contacts 104.

As also illustrated in FIG. 5, a contact component 504 is provided for maintaining a contact list 506 to identify the contacts 104 to be tagged. It is to be appreciated that, as used herein, contacts 104 can be an individual or a pre-existing meeting. One of the contacts 104 can include a group list with multiple individuals. In this way, a roster of regular meeting participants can be maintained, which can be selected as one of the contacts 104. This can be beneficial for selecting a specific group that meets regularly. By tagging a meeting, the system can notify the organizer when an entire group is available for an ad hoc pre-meeting conference, prior to convening the meeting. The contact list 506 can include entries for individuals, lists, and/or meetings.

As additionally illustrated in FIG. 5, the contact list 506 can also include metadata 508 related to each of the contacts 104 to provide additional information about the contacts 104 to be tagged. The metadata 508 can be derived from an address book, a communications application, or a document management system, for example. The metadata 508 can also be derived from an Internet social networking application, for example. The metadata 508 can also be used to edit the tagging process to add more information to the context 202, to determine specific activities in addition to availability.

As also illustrated in FIG. 5, the system 500 can include an optional selection component 510 for enabling the contacts 104 to selectively opt-in or opt-out of tagging and notification. The optional selection component 510 can be used by one of the contacts 104 to block access to availability status 402. In this way, the system 500 cannot be used simply to monitor the availability of contacts 104, thereby preserving an aspect of privacy.

As also illustrated in FIG. 5, a group communication component 512 cooperates with the notification component 108 to initiate a group communication with the contacts 104 via the notification 110. The notification 110 can include a button or other actionable element for creating and joining an online meeting. In this manner, all the contacts 104 can communicate as a group as soon as everyone becomes available. This can save time and thereby improve efficiency and productivity.

Scenarios follow herewith explaining a process of tagging and notification in accordance with the herein disclosed embodiments. In one scenario, a group of individuals can be tagged. A user plans to meet with three team members when available. A single alert notification on the team members can be set so that the tagging user is notified when all three are available at same time.

In another scenario, a meeting can be tagged. User A has a meeting scheduled with Users B, C, and D. User A tags that meeting for a status alert to discuss topics with the participants before the meeting. The next time when all three attendees are available, User A gets notified. This will enable User A to start an ad hoc conversation with B, C, and D prior to the meeting, for example, and/or post meeting.

In an additional scenario, context can be passed for tagged contacts or meetings. While tagging a group of contacts or meetings, a user can either pass the context explicitly by leaving a note or context can be computed automatically based on available meeting information.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

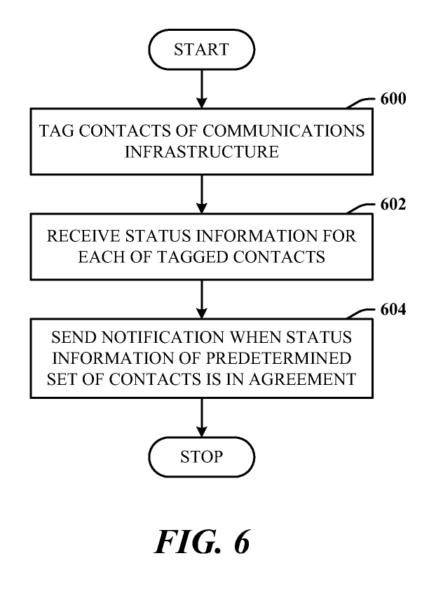

FIG. 6 illustrates a method of tagging contacts and sending notification when the contacts are concurrently available for a meeting. At 600, contacts of a communications infrastructure are tagged. At 602, status information for each of the tagged contacts is received. At 604, a notification is sent when the status information of a predetermined set of the contacts is in agreement. It is within the scope of the subject architecture that the term “concurrently” can also include changes in status that occur within a predetermined period of time (e.g., within one minute after the first received status), such that agreement can be satisfied if all status information occurs within the designated period of time.

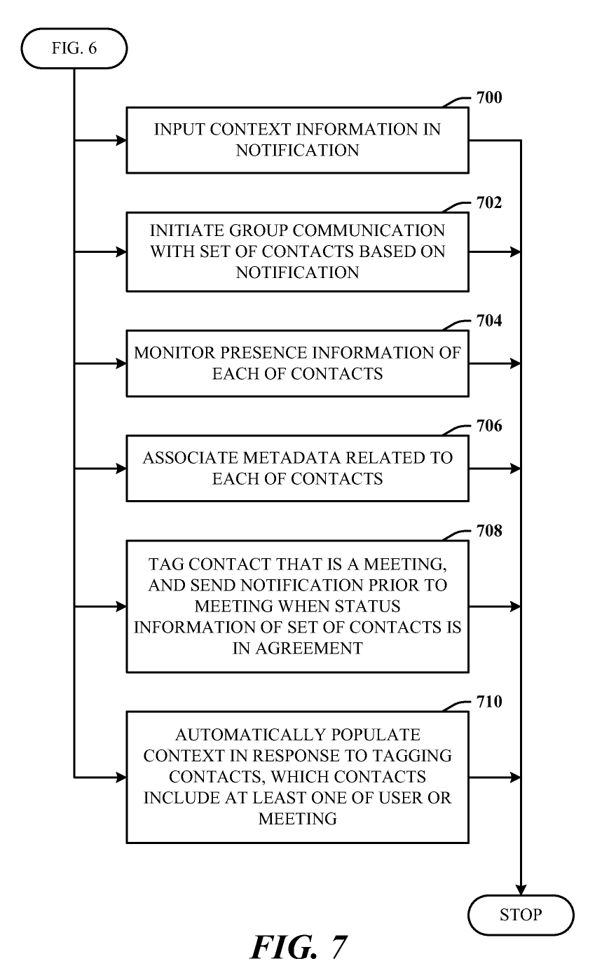

FIG. 7 illustrates additional aspects of the method of tagging contacts and sending notification when the contacts are concurrently available. At 700, context information is input in the notification. At 702, a group communication is initiated with the set of the contacts based on the notification. At 704, presence information of each of the contacts is monitored. At 706, metadata related to each of the contacts is associated with the contacts. At 708, a contact that is a meeting is tagged and the notification is sent prior to the meeting when the status information of the set of contacts is in agreement. The meeting can be a calendar meeting scheduled in a calendar or other type of scheduling application. One of the problems in meetings today is that the people have to wait for everyone to join/make quorum until the meeting starts. The meeting can group tag for presence, and the meeting will start automatically when everyone's presence is available. Everyone gets notified, the phone rings automatically, and they pick up to join the conference. At 710, the context is automatically populated in response to tagging the contacts, which contacts include at least one of a user or a meeting.

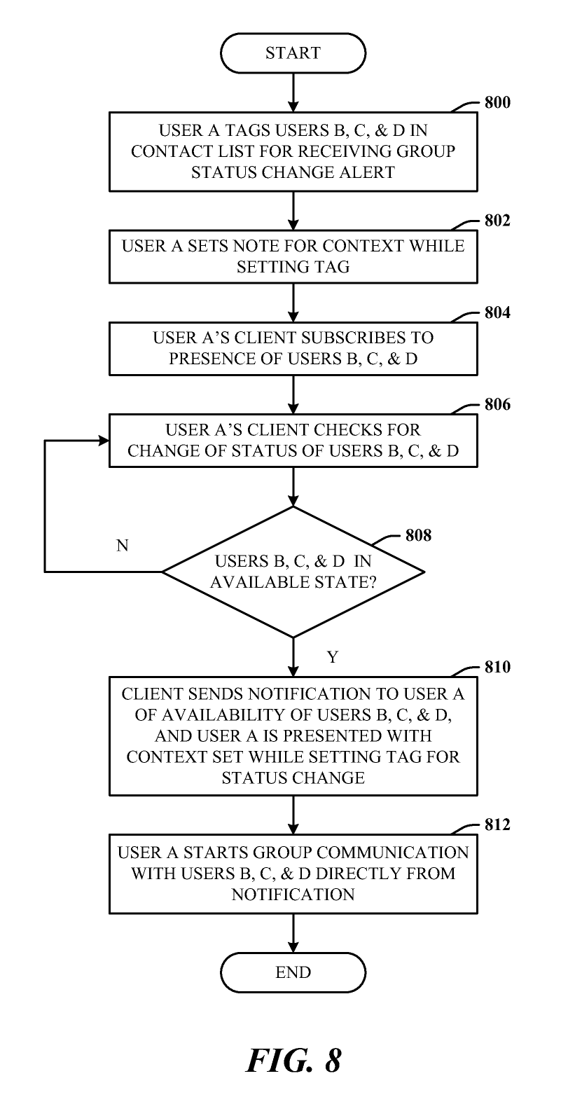

FIG. 8 illustrates a flow chart of an implementation in accordance with the disclosed embodiments. At 800, User A tags Users B, C, and D in a contact list for receiving a group status change alert. At 802, User A also sets a note for the context while setting the tag. At 804, User A's client application subscribes to presence information of Users B, C, and D. Subscription can have already occurred, or it can occur in response to the tagging operation. At 806, User A's client checks for change in status and agreement in the available state of Users B, C, and D. This can include an indication of whether the users are busy, but not in a meeting state, for example. If not, at 808, flow is to 806 to continue checking user status. If yes, at 808, flow is to 810 where the client send a notification to User A of the availability of Users B, C, and D, and User A is also presented with a context set while setting a tag for status change. At 812, User A can start a group communication with Users B, C, and D directly from notification.

In accordance with the flow of FIG. 8, similar flow can be defined for tagging meetings. A user can open a meeting from a client and tag the meeting itself for a status alert. The flow is similar except insofar the system can auto compute the tagged contacts from the participant list of the meeting. Additionally, the meeting subject can be stored and presented as part of the context.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

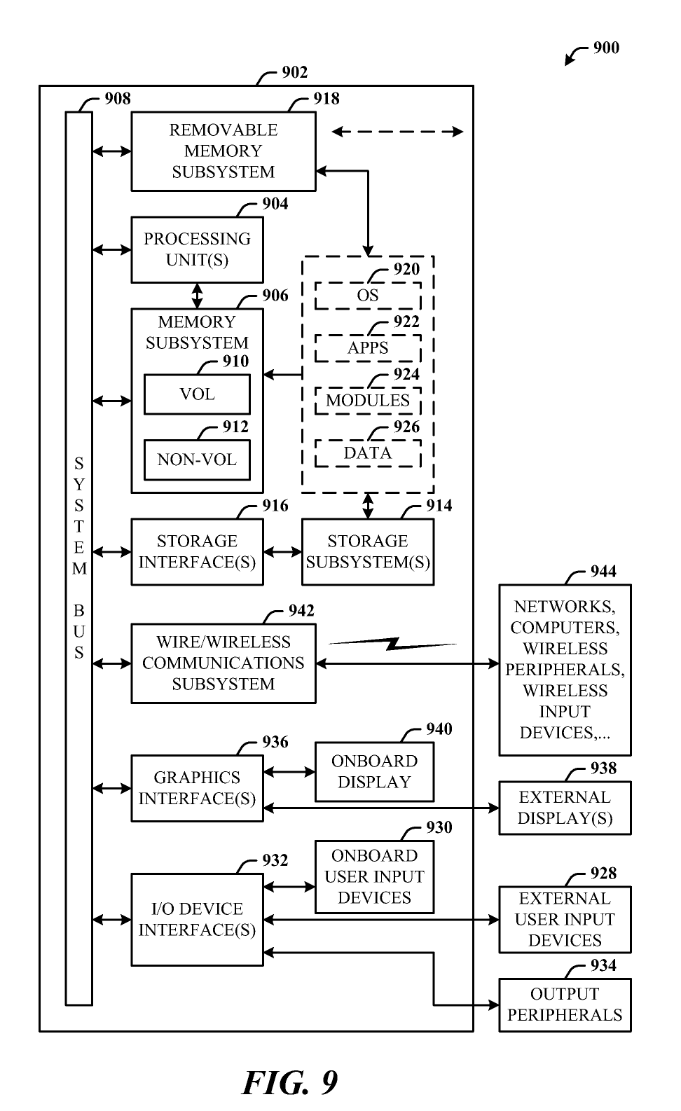

Referring now to FIG. 9, there is illustrated a block diagram of a computing system 900 operable to execute availability notification of a group of meeting participants in accordance with the disclosed architecture. In order to provide additional context for various aspects thereof, FIG. 9 and the following discussion are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the memory subsystem 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The aforementioned application programs 922, program modules 924, and program data 926 can include the computer implemented system 100 and the components and entities thereof such as the tagging component 102, the contacts 104, the communications session 106, the notification component 108, and the notification 110 of FIG. 1, the system 200 and the components and entities thereof such as the context component 202, the context 204, the note component 206, and the auto-population component 208 of FIG. 2, the system 300 and the components and entities thereof such as the presentation component 302, the status change component 304, the status 306, the presence component 308, and the presence information 310 of FIG. 3.

The aforementioned application programs 922, program modules 924, and program data 926 can also include the system 400 and the components and entities thereof such as the tagging component 102, the communications session 106, the context component 204, the context 202, the contacts 104, the status change component 304, the availability status 402, the notification component 108, and the notification 110 of FIG. 4, the system 500 and the components and entities thereof. such as the subscription component 502, the contact component 504, the contact list 506, the metadata 508, the optional selection component 510, and the group communication component 512 of FIG. 5, and the methods represented by the flow charts of FIGS. 6-8, for example.

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile media, removable and non-removable media. For the computer 902, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP) using logical connections via a wired/wireless communications subsystem 942 to one or more networks and/or other computers. The other computers can include workstations, servers, routers, personal computers, microprocessor-based entertainment appliance, a peer device or other common network node, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or has other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

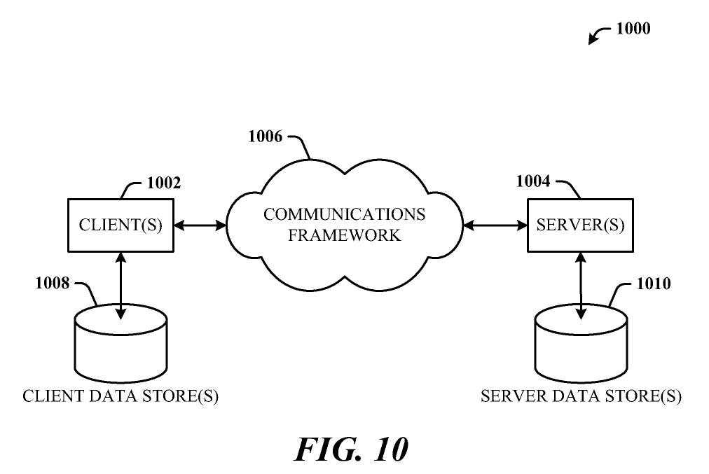

Referring now to FIG. 10, there is illustrated a schematic block diagram of a computing environment 1000 that can be used for performing availability notification of a group of meeting participants. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented notification system, comprising:
a tagging component for tagging contacts of a communications framework for participation in a communications session; and
a notification component for sending a notification when the tagged contacts are concurrently available to participate in the session.

2. The system of claim 1, further comprising a context component for indicating a context for the contacts.

3. The system of claim 2, further comprising a note component of the context component for entering a note to indicate the context for the contacts.

4. The system of claim 2, further comprising an auto-population component for automatically populating the context of the contacts.

5. The system of claim 1, further comprising a presentation component for presenting the context communicated in the notification.

6. The system of claim 1, further comprising a status change component for indicating changes in status of each of the contacts.

7. The system of claim 1, further comprising a presence component for monitoring presence information of the contacts, the presence information utilized for determining when the contacts are concurrently available to participate in the session.

8. A computer-implemented notification system, comprising:
a tagging component for tagging contacts of a communications framework for participation in a communications session;
a context component for indicating a context for tagging the contacts;
a status change component for detecting an availability status of the contacts to participate in the communications session; and
a notification component for sending a notification of concurrent availability of the contacts and the context.

9. The system of claim 8, wherein the notification component sends the notification based on a predetermined composition of the contacts that become available for the session.

10. The system of claim 8, further comprising a contact component for maintaining a contact list and identifying contacts of the list to be tagged, the contacts include at least one of a user, a meeting of multiple users, or members of an email distribution list.

11. The system of claim 10, wherein the contact list comprises metadata related to each contact, to provide information for the contacts to be tagged.

12. The system of claim 8, wherein the context component passes the context of tagged user contacts and tagged meeting contacts explicitly or automatically.

13. The system of claim 8, further comprising a group communications component for automatically initiating group communications with the tagged contacts via the notification.

14. A computer-implemented method of notification, comprising:
tagging contacts of a communications infrastructure;
receiving status information for each of the tagged contacts; and
sending a notification when the status information of a predetermined set of the contacts is in agreement.

15. The method of claim 14, further comprising inputting context information in the notification.

16. The method of claim 14, further comprising initiating a group communication with the set of contacts based on the notification.

17. The method of claim 14, further comprising monitoring presence information of each of the contacts.

18. The method of claim 14, further comprising associating metadata related to each of the contacts with the contacts.

19. The method of claim 14, further comprising tagging a contact that is a meeting, and sending the notification prior to the meeting when the status information of the set of contacts is in agreement.

20. The method of claim 14, further comprising automatically populating context in response to tagging the contacts, which contacts include at least one of a user or a meeting.
